(19) United States
(12) Patent Application Publication
(10) Pub. No.: US 2009/0181273 A1
(43) Pub. Date: Jul. 16, 2009

(54) FUEL CELL SYSTEM

(75) Inventors: Jin-Shu Huang, Hsinchu (TW); Ching-Po Lee, Hsinchu (TW); Cheng Wang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsin-Chu (TW)

(21) Appl. No.: 12/182,144

(22) Filed: Jul. 30, 2008

(30) Foreign Application Priority Data
Jan. 11, 2008 (TW) 97101191

(51) Int. Cl. H01M 8/04

(52) U.S. Cl. 429/26

(57) ABSTRACT

A fuel cell system includes a first airflow generator, a first fuel cell module, a second airflow generator and a second fuel cell module. The first airflow generator is capable of providing a first airflow, which flows through the first fuel cell module. The second airflow generator is capable of providing a second airflow, which flows through the second fuel cell module. A heat exchange is proceeded between the first airflow departing from the first fuel cell module and the second airflow prior to entering the second fuel cell module, and another heat exchange is proceeded between the second airflow departing from the second fuel cell module and the first airflow prior to entering the first fuel cell module.

### CROSS-REFERENCE TO RELATED APPLICATION

This application claims the priority benefit of Taiwan application serial no. 97101191, filed Jan. 11, 2008. The entirety of the above-mentioned patent application is hereby incorporated by reference herein and made a part of this specification.

### BACKGROUND OF THE INVENTION

1. Field of the Invention

The present invention generally relates to a battery system, and more particularly, to a fuel cell system.

2. Description of Related Art

Along with the progress of science and technology, the consumption of traditional energy sources, such as coal, petroleum and natural gas steadily grows up. Due to a limited storage of the traditional energy, all the countries are currently developing new alternative energy sources to replace the traditional energy sources, wherein fuel cell is counted as an important and valuable choice.

In short, a fuel cell is basically an electrical generating apparatus taking advantage of reverse reaction of water electrolysis so as to convert chemical energy into electrical energy. The common fuel cell currently includes phosphate fuel cell (PAFC), solid oxide fuel cell (SOFC) or proton exchange membrane fuel cell (PEMFC).

Taking the PEMFC as an example, the PEMFC includes a first fuel (for example, methanol aqueous solution), a second fuel (for example, oxygen), a proton exchange membrane and a cathode and an anode respectively located at both sides of the proton exchange membrane. The reaction formulas in the above-mentioned PEMFC are as follows:

at anode: CH₃OH+H₂O→CO₂+6H⁺+6e⁻

at cathode: 3/2O₂+6H⁺+6e^{-→}3H₂O

total reaction: CH₃OH+3/2O₂→CO₂+2H₂O

It can be seen from the above-mentioned formulas that during the reaction of the fuel cell, sufficient oxygen is required to be supplied to the cathode. In addition, the higher the reaction temperature of the fuel cell is, the better the reaction efficiency thereof is.

FIG. 1 is a schematic top view of a conventional fuel cell system. Referring to FIG. 1, a conventional fuel cell system 100 includes a first fuel cell module 110, a second fuel cell module 120, a first blower 130, a second blower 140, a third blower 150 and a condenser 160. The first blower 130 provides a first airflow 132 flowing through the first fuel cell module 110 so as to provide the cathode (not shown) of the first fuel cell module 110 with sufficient air. The second blower 140 provides a second airflow 142 flowing through the second fuel cell module 120 so as to provide the cathode (not shown) of the second fuel cell module 120 with sufficient air.

Both the first airflow 132 with a higher temperature departing from the first fuel cell module 110 and the second airflow 142 with a higher temperature departing from the second fuel cell module 120 flow through the condenser 160. Meanwhile, the third blower 150 provides a third airflow 152 with a lower temperature, and the third airflow 152 flows through the condenser 160 such that the temperatures of the first airflow 132 and the second airflow 142 are reduced and thereby a part of moisture in the first airflow 132 and the second airflow 142 condenses into liquid water, so as to achieve the purpose of water recovery, wherein the recovered water may be used in the chemical reaction occurring at the anodes. However, with the above-mentioned scheme, the first airflow 132 and the second airflow 142 would respectively lower the temperatures of the reactions in the first fuel cell module 110 and in the second fuel cell module 120 such that the reaction rates of the first fuel cell module 110 and the second fuel cell module 120 are reduced.

### SUMMARY OF THE INVENTION

Accordingly, a fuel cell system including fuel cell modules is provided in an embodiment of the present invention, wherein the fuel cell modules having a better reaction rate.

Other advantages and objects of the present invention may be further comprehended through the technical features disclosed in the present invention.

To achieve one of, a part of or all of the above-mentioned objectives, or to achieve other objectives, an embodiment of the present invention provides a fuel cell system, which includes a first airflow generator, a first fuel cell module, a second airflow generator and a second fuel cell module. The first airflow generator is capable of providing a first airflow and has a first air inlet and a first air outlet. The first fuel cell module has a second air inlet and a second air outlet. The first airflow sequentially flows through the first air inlet, the inside of the first airflow generator, the first air outlet, the second air inlet, the inside of the first fuel cell module and the second air outlet. The second airflow generator is capable of providing a second airflow and has a third air inlet and a third air outlet. The second fuel cell module has a fourth air inlet and a fourth air outlet. The second airflow sequentially flows through the third air inlet, the inside of the second airflow generator, the third air outlet, the fourth air inlet, the inside of the second fuel cell module and the fourth air outlet. A heat exchange is proceeded between the first airflow departing from the first fuel cell module and the second airflow prior to entering the second fuel cell module, and another heat exchange is proceeded between the second airflow departing from the second fuel cell module and the first airflow prior to entering the first fuel cell module.

Since a heat exchange is proceeded between the first airflow departing from the first fuel cell module and the second airflow prior to entering the second fuel cell module, and another heat exchange is proceeded between the second airflow departing from the second fuel cell module and the first airflow prior to entering the first fuel cell module, thus, the temperature of the first airflow prior to entering the first fuel cell module and the temperature of the second airflow prior to entering the second fuel cell module may be promoted. Accordingly, when the first airflow and the second airflow respectively flow through the first fuel cell module and the second fuel cell module, the reaction rates of the first fuel cell module and the second fuel cell module may be effectively increased.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic top view of a conventional fuel cell system.

FIG. 2 is a schematic top view of a fuel cell system according to the first embodiment of the present invention.

FIG. 3 is a schematic top view of a fuel cell system according to the second embodiment of the present invention.

FIG. 4A is a schematic top view of a fuel cell system according to the third embodiment of the present invention.

FIG. 4B is a schematic side view of the fuel cell system of FIG. 4A.

FIG. 5A is a schematic top view of a fuel cell system according to the fourth embodiment of the present invention.

FIG. 5B is a schematic side view of the fuel cell system of FIG. 5A.

FIG. 6 is a schematic top view of a fuel cell system according to the fifth embodiment of the present invention

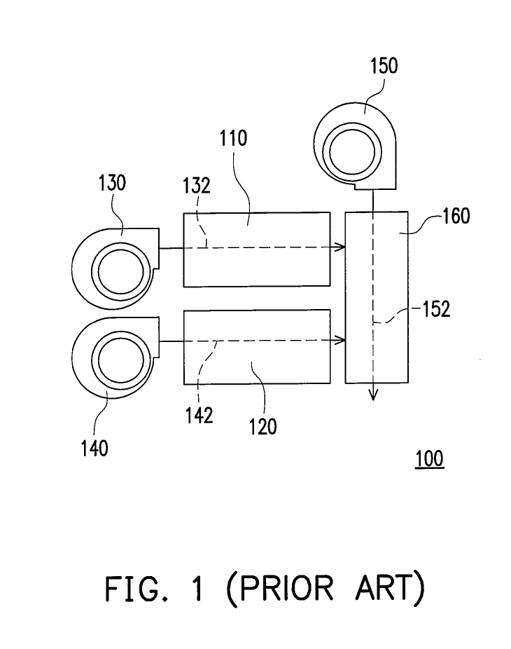

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless limited otherwise, the terms I“connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

### The First Embodiment

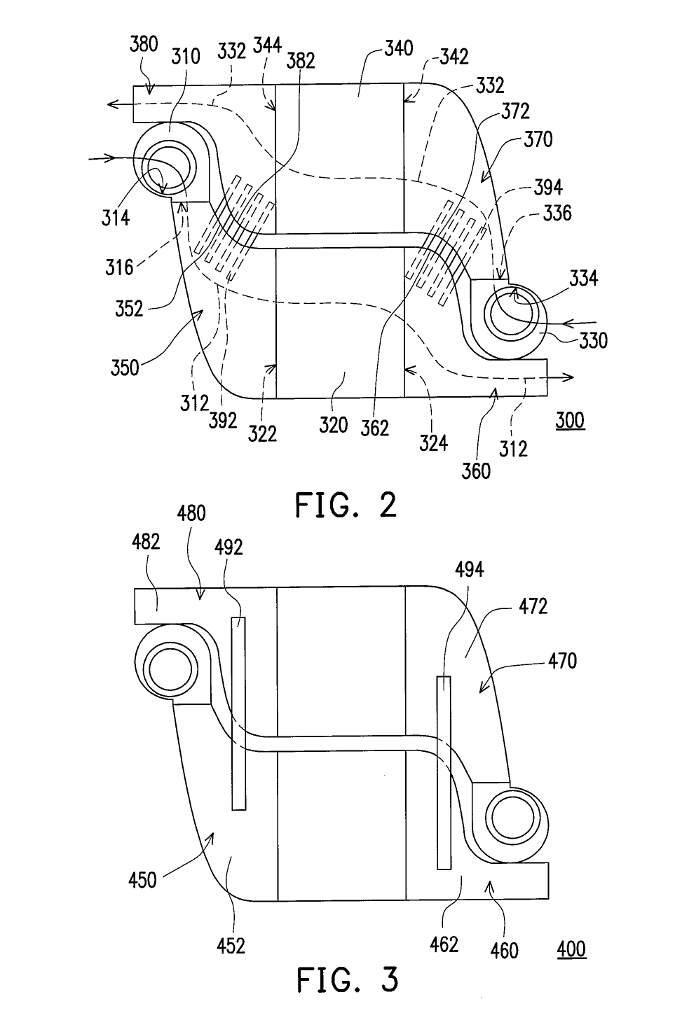

FIG. 2 is a schematic top view of a fuel cell system according to the first embodiment of the present invention. Referring to FIG. 2, a fuel cell system 300 of the embodiment is applied to, for example, a notebook computer (not shown) or other electronic devices. The fuel cell system 300 includes a first airflow generator 310, a first fuel cell module 320, a second airflow generator 330 and a second fuel cell module 340. The first airflow generator 310 is, for example, a blower or an axial fan and the second airflow generator 330 is, for example, a blower or an axial fan.

The first airflow generator 310 is capable of providing a first airflow 312 and has a first air inlet 314 and a first air outlet 316. The first fuel cell module 320 has a second air inlet 322 and a second air outlet 324. The first airflow 312 sequentially flows through the first air inlet 314, the inside of the first airflow generator 310, the first air outlet 316, the second air inlet 322, the inside of the first fuel cell module 320 and the second air outlet 324.

In other words, when the first airflow generator 310 operates, the first airflow 312 passes through the first air inlet 314 and enters the inside of the first airflow generator 310. After the first airflow 312 is pressurized by a plurality of fan blades (not shown) of the first airflow generator 310, the first airflow 312 departs from the first airflow generator 310 via the first air outlet 316. Then, the first airflow 312 flows through inside the first fuel cell module 320 to provide the cathode (not shown) of the first fuel cell module 320 with sufficient air.

The second airflow generator 330 is capable of provide a second airflow 332 and has a third air inlet 334 and a third air outlet 336. The second fuel cell module 340 has a fourth air inlet 342 and a fourth air outlet 344. The second airflow 332 sequentially flows through the third air inlet 334, the inside of the second airflow generator 330, the third air outlet 336, the fourth air inlet 342, the inside of the second fuel cell module 340 and the fourth air outlet 344.

In other words, when the second airflow generator 330 operates, the second airflow 332 passes through the third air inlet 334 and enters the inside of the second airflow generator 330. After the second airflow 332 is pressurized by a plurality of fan blades (not shown) of the second airflow generator 330, the second airflow 332 departs from the second airflow generator 330 via the third air outlet 336. Then, the second airflow 332 flows through the inside of the second fuel cell module 340 to provide the cathode (not shown) of the second fuel cell module 340 with sufficient air.

Note that a heat exchange is proceeded between the first airflow 312 departing from the first fuel cell module 320 and the second airflow 332 prior to entering the second fuel cell module 340. Namely, heat is transferred from the first airflow 312 with a higher temperature departing from the first fuel cell module 320 to the second airflow 332 with a lower temperature prior to entering the second fuel cell module 340 so as to achieve the purpose of heat recovery. In addition, another heat exchange is proceeded between the second airflow 332 departing from the second fuel cell module 340 and the first airflow 312 prior to entering the first fuel cell module 320. Namely, heat is transferred from the second airflow 332 with a higher temperature departing from the second fuel cell module 340 to the first airflow 312 with a lower temperature prior to entering the first fuel cell module 320 so as to achieve the purpose of heat recovery.

It can be seen from the above description that the temperature of the first airflow 312 prior to entering the first fuel cell module 320 and that of the second airflow 332 prior to entering the second fuel cell module 340 may be promoted. Therefore, in comparison with the prior art, when the first airflow 312 and the second airflow 332 of the embodiment respectively flow through the first fuel cell module 320 and the second fuel cell module 340, the reaction rates of the first fuel cell module 320 and the second fuel cell module 340 may be effectively increased.

In the embodiment, the fuel cell system 300 further includes a first air duct 350, a second air duct 360, a third air duct 370 and a fourth air duct 380. Two ends of the first air duct 350 are respectively adjacent to the first air outlet 316 and the second air inlet 322, and the first airflow 312 prior to entering the first fuel cell module 320 flows through the first air duct 350. The second air duct 360 is adjacent to the second air outlet 324, and the first airflow 312 departing from the first fuel cell module 320 flows through the second air duct 360. Note that in the embodiment, the first air duct 350 connects the first air outlet 316 and the second air inlet 322, and the second air duct 360 connects the second air outlet 324.

Two ends of the third air duct 370 are respectively adjacent to the third air outlet 336 and the fourth air inlet 342, and the second airflow 332 prior to entering the second fuel cell module 340 flows through the third air duct 370. The fourth air duct 380 is adjacent to the fourth air outlet 344, and the second airflow 332 departing from the second fuel cell module 340 flows through the fourth air duct 380. In the embodiment, the third air duct 370 connects the third air outlet 336 and the fourth air inlet 342, and the fourth air duct 380 connects the fourth air outlet 344. In addition, the second air duct 360 is thermally coupled to the third air duct 370, and the first air duct 350 is thermally coupled to the fourth air duct 380.

In more detail, in the embodiment, the fuel cell system 300 further includes at least a first heat conduction element 392 and at least a second heat conduction element 394 (a plurality of first heat conduction elements 392 and second heat conduction elements 394 are shown in FIG. 2). The first heat conduction elements 392 is, for example, a fin and the second heat conduction elements 394 is, for example, a fin. An end of the first heat conduction elements 392 passes through a pipe wall 352 of the first air duct 350 and extends into the first air duct 350, and another end of the first heat conduction elements 392 passes through a pipe wall 382 of the fourth air duct 380 and extends into the fourth air duct 380, so that the first heat conduction elements 392 is thermally coupled to the first air duct 350 and the fourth air duct 380.

In addition, an end of each of the second heat conduction elements 394 passes through a pipe wall 362 of the second air duct 360 and extends into the second air duct 360, and another end of each of the second heat conduction elements 394 passes through a pipe wall 372 of the third air duct 370 and extends into the third air duct 370, so that the second heat conduction elements 394 is thermally coupled to the second air duct 360 and the third air duct 370.

Note that when the second airflow 332 departing from the second fuel cell module 340 passes through the first heat conduction elements 392, the temperature of the second airflow 332 would be lowered such that a part of moisture in the second airflow 332 condenses into liquid water. The fourth air duct 380 may be placed in a tilt by design, so that the liquid water flows to a water-recovery apparatus (not shown) along the direction of gravity. Besides, after the liquid water is recovered, the recovered water may be used in the chemical reaction occurring at the anode (not shown) of the second fuel cell module 340. Similarly, when the first airflow 312 departing from the first fuel cell module 320 passes through the second heat conduction elements 394, a part of moisture in the first airflow 312 condenses into liquid water for recovery purpose.

Note that the fuel cell system 300 may be configured without the first heat conduction elements 392 and the second heat conduction elements 394. The second air duct 360 contacts the third air duct 370 such that the second air duct 360 is thermally coupled to the third air duct 370. The first air duct 350 contacts the fourth air duct 380 such that the first air duct 350 is thermally coupled to the fourth air duct 380 (the above-described case is not shown herein yet).

### The Second Embodiment

FIG. 3 is a schematic top view of a fuel cell system according to the second embodiment of the present invention. Referring to FIG. 3, the major difference of a fuel cell system 400 of the embodiment from the fuel cell system 300 of the first embodiment is that a first heat conduction element 492 of the fuel cell system 400 is a heat pipe, and a second heat conduction element 494 is a heat pipe too. For example, the first heat conduction element 492 being a heat pipe or the second heat conduction element 494 being a heat pipe contains fluid with high specific heat or volatility (not shown), and the fluid may be converted between liquid phase and gas phase so as to promote the heat conduction efficiency of the first heat conduction element 492 or that of the second heat conduction element 494.

In the embodiment, the first heat conduction element 492 is located outside a first air duct 450 and a fourth air duct 480, and two ends of the first heat conduction element 492 respectively contact a pipe wall 452 of the first air duct 450 and a pipe wall 482 of the fourth air duct 480. The second heat conduction element 494 is located outside a second air duct 460 and a third air duct 470, and two ends of the second heat conduction element 494 respectively contact a pipe wall 462 of the second air duct 460 and a pipe wall 472 of the third air duct 470.

For example, the first heat conduction element 492 being a heat pipe may pass through the pipe wall 452 of the first air duct 450 and the pipe wall 482 of the fourth air duct 480, and therefore the two ends of the first heat conduction element 492 are respectively located in the first air duct 450 and the fourth air duct 480. For example, the second heat conduction element 494 being a heat pipe may also pass through the pipe wall 462 of the second air duct 460 and the pipe wall 472 of the third air duct 470, and therefore the two ends of the second heat conduction element 494 are respectively located in the second air duct 460 and the third air duct 470 (the above-described case is not shown herein yet).

### The Third Embodiment

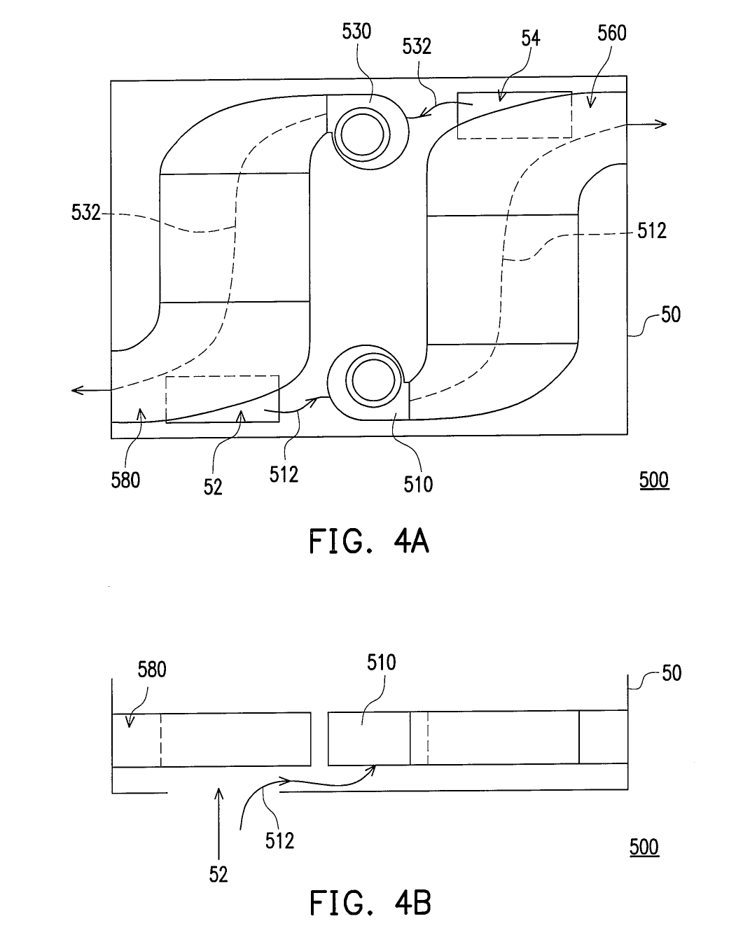

FIG. 4A is a schematic top view of a fuel cell system according to the third embodiment of the present invention, and FIG. 4B is a schematic side view of the fuel cell system of FIG. 4A. Referring to FIGS. 4A and 4B, the major difference of a fuel cell system 500 of the embodiment from the fuel cell system 300 of the first embodiment is that the fuel cell system 500 may be configured without the first heat conduction element 392 (shown in FIG. 2) and the second heat conduction element 394 (shown in FIG. 2). In, addition, in the embodiment, a heat exchange is proceeded between a first airflow 512 prior to entering a first airflow generator 510 and a fourth air duct 580, and another heat exchange is proceeded between a second airflow 532 prior to entering a second airflow generator 530 and a second air duct 560.

In more details, when the fuel cell system 500 of the embodiment is disposed in a casing 50 of an electronic device (for example, a notebook computer, which is not completely shown in the figures), the casing 50 has a first opening 52 and a second opening 54, wherein positions of the first opening 52 and the second opening 54 are respectively corresponding to positions of the fourth air duct 580 and the second air duct 560, so that the first airflow 512 and the second airflow 532 respectively flow through the first opening 52 and the second opening 54, and heat exchanges are respectively proceeded between the first airflow 512 and the fourth air duct 580 and between the second airflow 532 and the second air duct 560.

### The Fourth Embodiment

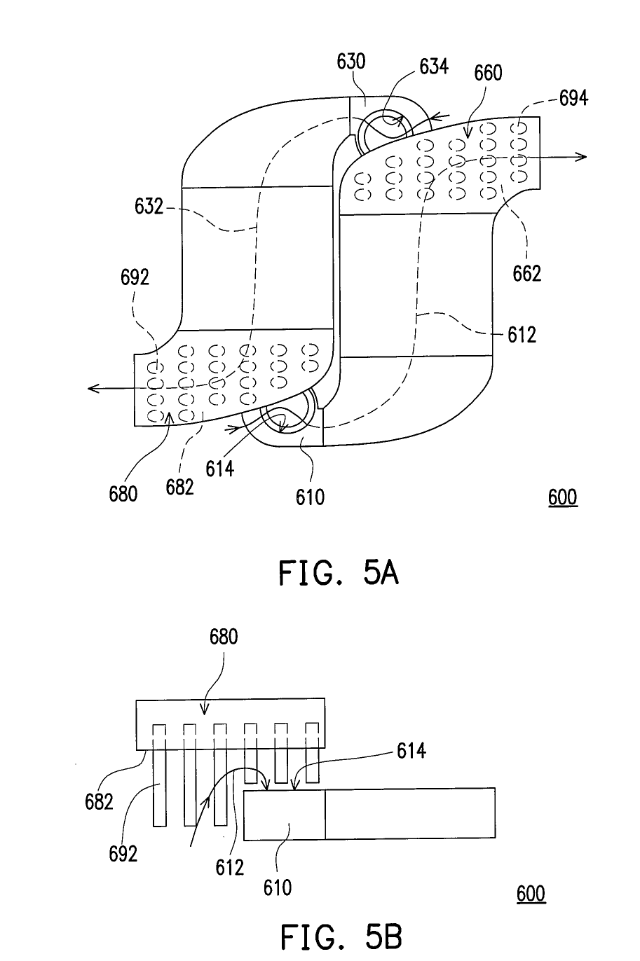

FIG. 5A is a schematic top view of a fuel cell system according to the fourth embodiment of the present invention and FIG. 5B is a schematic side view of the fuel cell system of FIG. 5A. Referring to FIGS. 5A and 5B, the major difference of a fuel cell system 600 of the embodiment from the fuel cell system 500 of the third embodiment is that the fuel cell system 600 further includes at least a first heat conduction element 692 and at least a second heat conduction element 694 (a plurality of 692 and 694 are shown in FIGS. 5A and 5B). The first heat conduction element 692 is, for example, a heat-conducting pin and the second heat conduction element 694 is, for example, a heat-conducting pin.

In addition, an end of the first heat conduction element 692 is adjacent to a first air inlet 614 of a first airflow generator 610, and another end of each the first heat conduction element 692 passes through a pipe wall 682 of a fourth air duct 680 and extends into the fourth air duct 680. An end of each the second heat conduction element 694 is adjacent to a third air inlet 634 of a second airflow generator 630, and another end of each the second heat conduction element 694 passes through a pipe wall 662 of a second air duct 660 and extends into the second air duct 660. In addition, heat exchanges are proceeded between a first airflow 612 prior to entering the first airflow generator 610 and the first heat conduction element 692 and between the first airflow 612 prior to entering the first airflow generator 610 and the fourth air duct 680. Heat exchanges are proceeded between a second airflow 632 prior to entering the second airflow generator 630 and the second heat conduction element 694 and between the second airflow 632 prior to entering the second airflow generator 630 and the second air duct 660.

### The Fifth Embodiment

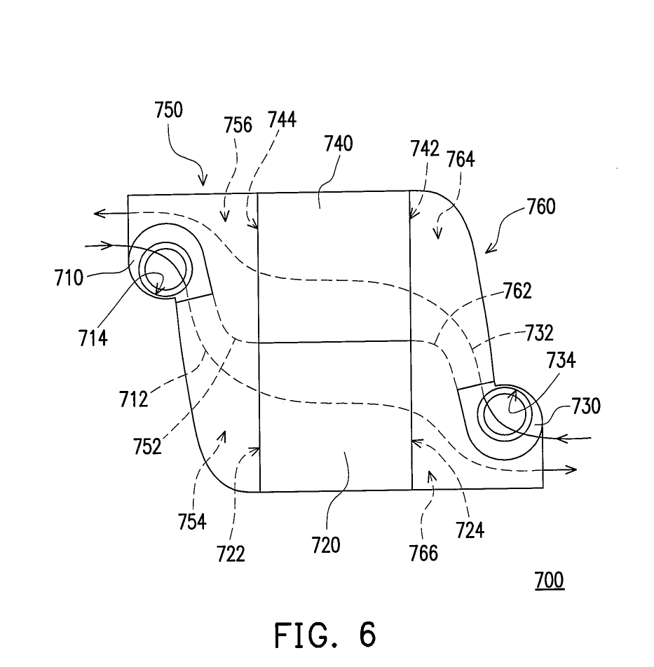

FIG. 6 is a schematic top view of a fuel cell system according to the fifth embodiment of the present invention. Referring to FIG. 6, the major difference of the embodiment from the above-mentioned embodiments is that a fuel cell system 700 of the embodiment further includes a first air-guiding casing 750 and a second air-guiding casing 760. The first air-guiding casing 750 is adjacent to a second air inlet 722 of a first fuel cell module 720 and a fourth air outlet 744 of a second fuel cell module 740. In the embodiment, the first air-guiding casing 750 is, for example, connected to the second air inlet 722 of the first fuel cell module 720 and the fourth air outlet 744 of the second fuel cell module 740.

The first air-guiding casing 750 has a first heat conduction baffle 752, and the first heat conduction baffle 752 partitions off a first flow way 754 and a second flow way 756 in the first air-guiding casing 750. In the embodiment, a first airflow generator 710 is disposed in the first air-guiding casing 750 and located in the first flow way 754, and a first air inlet 714 of the first airflow generator 710 is exposed to outside.

The second air-guiding casing 760 is adjacent to a fourth air inlet 742 of the second fuel cell module 740 and a second air outlet 724 of the first fuel cell module 720. In the embodiment, the second air-guiding casing 760 is, for example, connected to the fourth air inlet 742 of the second fuel cell module 740 and the second air outlet 724 of the first fuel cell module 720.

The second air-guiding casing 760 has a second heat conduction baffle 762, and the second heat conduction baffle 762 partitions off a third flow way 764 and a fourth flow way 766 in the second air-guiding casing 760. In the embodiment, a second airflow generator 730 is disposed in the second air-guiding casing 760 and located in the third flow way 764, and a third air inlet 734 of the second airflow generator 730 is exposed to outside.

In more detail, a first airflow 712 provided by the first airflow generator 710 passes through the first flow way 754, enters the first fuel cell module 720, departs from the first fuel cell module 720 and then is expelled from the fuel cell system 700 via the fourth flow way 766. A second airflow 732 provided by the second airflow generator 730 passes through the third flow way 764, enters the second fuel cell module 740, departs from the second fuel cell module 740 and then is expelled from the fuel cell system 700 via the second flow way 756.

In summary, the fuel cell system according to the above-mentioned embodiments of the present invention has one of, a part of or all of the following advantages:

1. Since a heat exchange is proceeded between the first airflow departing from the first fuel cell module and the second airflow prior to entering the second fuel cell module, and another heat exchange is proceeded between the second airflow departing from the second fuel cell module and the first airflow prior to entering the first fuel cell module, therefore, the temperature of the first airflow prior to entering the first fuel cell module and that of the second airflow prior to entering the second fuel cell module may be promoted. Accordingly, the reaction rates of the first fuel cell module and the second fuel cell module may be effectively increased when the first airflow and the second airflow respectively pass through the first fuel cell module and the second fuel cell module.

2. Since a heat exchange is proceeded between the first airflow departing from the first fuel cell module and the second airflow prior to entering the second fuel cell module, and another heat exchange is proceeded between the second airflow departing from the second fuel cell module and the first airflow prior to entering the first fuel cell module, therefore, a part of the moisture in the first airflow departing from the first fuel cell module and a part of the moisture in the second airflow departing from the second fuel cell module condense into liquid water so as to achieve the purpose of water recovery.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A fuel cell system, comprising:
a first airflow generator, capable of providing a first airflow and having a first air inlet and a first air outlet;
a first fuel cell module, having a second air inlet and a second air outlet, wherein the first airflow sequentially flows through the first air inlet, the inside of the first airflow generator, the first air outlet, the second air inlet, the inside of the first fuel cell module and the second air outlet;
a second airflow generator, capable of providing a second airflow and having a third air inlet and a third air outlet; and
a second fuel cell module, having a fourth air inlet and a fourth air outlet, wherein the second airflow sequentially flows through the third air inlet, the inside of the second airflow generator, the third air outlet, the fourth air inlet, the inside of the second fuel cell module and the fourth air outlet; a heat exchange is proceeded between the first airflow departing from the first fuel cell module and the second airflow prior to entering the second fuel cell module, and another heat exchange is proceeded between the second airflow departing from the second fuel cell module and the first airflow prior to entering the first fuel cell module.

2. The fuel cell system according to claim 1, further comprising:
a first air duct, wherein two ends of the first air duct are respectively adjacent to the first air outlet and the second air inlet, and the first airflow prior to entering the first fuel cell module flows through the first air duct;
a second air duct, adjacent to the second air outlet, wherein the first airflow departing from the first fuel cell module flows through the second air duct;
a third air duct, wherein two ends of the third air duct are respectively adjacent to the third air outlet and the fourth air inlet, and the second airflow prior to entering the second fuel cell module flows through the third air duct; and
a fourth air duct, adjacent to the fourth air outlet, wherein the second airflow departing from the second fuel cell module flows through the fourth air duct.

3. The fuel cell system according to claim 2, wherein the first air duct connects the first air outlet and the second air inlet, the second air duct connects the second air outlet, the third air duct connects the third air outlet and the fourth air inlet, and the fourth air duct connects the fourth air outlet.

4. The fuel cell system according to claim 2, wherein the second air duct is thermally coupled to the third air duct and the first air duct is thermally coupled to the fourth air duct.

5. The fuel cell system according to claim 4, further comprising:
at least a first heat conduction element, thermally coupled to the first air duct and the fourth air duct; and
at least a second heat conduction element, thermally coupled to the second air duct and the third air duct.

6. The fuel cell system according to claim 5, wherein an end of the first heat conduction element passes through a pipe wall of the first air duct and extends into the first air duct, another end of the first heat conduction element passes through a pipe wall of the fourth air duct and extends into the fourth air duct, an end of the second heat conduction element passes through a pipe wall of the second air duct and extends into the second air duct, and another end of the second heat conduction element passes through a pipe wall of the third air duct and extends into the third air duct.

7. The fuel cell system according to claim 5, wherein the first heat conduction element is located outside the first air duct and the fourth air duct, two ends of the first heat conduction element respectively contact the pipe wall of the first air duct and the pipe wall of the fourth air duct, the second heat conduction element is located outside the second air duct and the third air duct, and two ends of the second heat conduction element respectively contact the pipe wall of the second air duct and the pipe wall of the third air duct.

8. The fuel cell system according to claim 4, wherein the second air duct contacts the third air duct and the first air duct contacts the fourth air duct.

9. The fuel cell system according to claim 2, wherein the heat exchange is proceeded between the first airflow prior to entering the first airflow generator and the fourth air duct, and the other heat exchange is proceeded between the second airflow prior to entering the second airflow generator and the second air duct.

10. The fuel cell system according to claim 9, further comprising:
at least a first heat conduction element, wherein an end of the first heat conduction element is adjacent to the first air inlet, and another end of the first heat conduction element passes through the pipe wall of the fourth air duct and extends into the fourth air duct; and
at least a second heat conduction element, wherein an end of the second heat conduction element is adjacent to the third air inlet, and another end of the second heat conduction element passes through the pipe wall of the second air duct and extends into the second air duct.

11. The fuel cell system according to claim 1, further comprising:
a first air-guiding casing, adjacent to the second air inlet and the fourth air outlet and comprising a first heat conduction baffle, wherein the first heat conduction baffle partitions off a first flow way and a second flow way in the first air-guiding casing, the first airflow passes through the first flow way and enters the first fuel cell module, and the second airflow departing from the second fuel cell module passes through the second flow way; and
a second air-guiding casing, adjacent to the fourth air inlet and the second air outlet and having a second heat conduction baffle, wherein the second heat conduction baffle partitions off a third flow way and a fourth flow way in the second air-guiding casing, the second airflow passes through the third flow way and enters the second fuel cell module, and the first airflow departing from the first fuel cell module passes through the fourth flow way.

12. The fuel cell system according to claim 11, wherein the first air-guiding casing connects the second air inlet and the fourth air outlet, and the second air-guiding casing connects the fourth air inlet and the second air outlet.
